(19) United States
(12) Patent Application Publication
(10) Pub. No.: US 2013/0192941 A1
(43) Pub. Date: Aug. 1, 2013

(54) Hydraulic brake

(71) Applicant: Chang Hui LIN, Hsiu Shui (TW)

(72) Inventor: Chang Hui LIN, Hsiu Shui (TW)

(21) Appl. No.: 13/783,502

(22) Filed: Mar. 4, 2013

Related U.S. Application Data
(63) Continuation-in-part of application No. 12/789,417, filed on May 27, 2010.

(51) Int. Cl. B62L 3/02

(52) U.S. Cl. CPC B62L 3/023
USPC 188/344

(57) ABSTRACT

A hydraulic brake is used to a handle of a two wheel vehicle and contains a body including two first tabs, the handle including an axial hole and a through bore to receive an adjustable nut having a screw aperture to be screwed with first threads of a connecting post of a hydraulic piston, the body including a retaining sleeve and two second tabs, a hydraulic cylinder including an oil chamber and fitted to a holder, a positioning nut having an orifice screwed with second threads of the hydraulic cylinder, the holder including a receiving room to receive an oil cup, a pore, and a cover, an outer diameter of the pore of the holder being equal to that of the hydraulic cylinder, the hydraulic piston including the connecting post, and the connecting post including the first threads to screw the connecting post with the orifice of the positioning nut.

This application is a Continuation-in-Part of application Ser. No. 12/789,417, filed May 27, 2010.

### BACKGROUND OF THE INVENTION

### Description of the Prior Art

As shown in FIG. 1, a conventional handle structure used in a brake of a bicycle includes a body 90 integrally formed by a casting or forging method, and then the body 90 is drilled and milled by using a lathe. The body 90 includes a hydraulic cylinder 91 work formed therein, and the hydraulic cylinder 91 includes a returning spring 92, a hydraulic piston 93, and a washer 94 installed therein, the body 90 includes a handle 95 disposed on a rear side thereof, an adjustable nut 97 and a push post 97 axially connected on a front side thereof, such that when the handle 95 is pressed, a head end 98 of the push post 97 is actuated to push the hydraulic piston 93, and then the hydraulic piston 93 pushes hydraulic oil in the hydraulic cylinder 91 to actuate a clamping and braking operation.

However, after the handle 95 of the body 90 is pressed, the push post 97 pushes the hydraulic piston 93, and then the push post 97 pushes the hydraulic cylinder at a certain angle. Because the push post 97 is axially connected on the handle 95, and between the push post 97 and the hydraulic cylinder 91 is defined a predetermined angle, transmitting power will lose to operate the brake dully. Moreover, the conventional handle structure includes many complicated components that have to be worked, increasing production cost.

The present invention has arisen to mitigate and/or obviate the afore-described disadvantages.

### SUMMARY OF THE INVENTION

The primary object of the present invention is to provide a hydraulic brake which is capable of overcoming the shortcomings of the conventional a hydraulic brake.

Another object of the present invention is to provide a hydraulic brake that after the handle of the two wheel vehicle is pressed, the hydraulic piston pushes hydraulic oil in an oil chamber directly, and then the hydraulic piston operates in the oil chamber, such that the hydraulic cylinder is micro-adjusted with a changing angle of the handle so that the hydraulic piston acts linearly, thus having a smooth brake and lowering weight.

To obtain the above objectives, a hydraulic brake provided by the present invention includes:

a body, a hydraulic cylinder, a hydraulic piston, a holder, and an adjustable nut, and the handle, wherein the body includes two first tabs disposed on an upper side thereof, the handle includes an axial hole and a through bore to receive the adjustable nut arranged on a front end thereof, the adjustable nut includes a screw aperture formed on a middle section thereof to be screwed with first threads of a connecting post of the hydraulic piston, the body includes a retaining sleeve and two second tabs disposed on a bottom side thereof, the hydraulic cylinder includes an oil chamber fixed on a central portion thereof and is fitted to the holder, a positioning nut having an orifice is screwed with second threads on a top end of the hydraulic cylinder so that the hydraulic piston is limited in the oil chamber to operate and the holder is not disengaged, the holder includes a receiving room to receive an oil cup and a pore arranged thereon, and includes a cover disposed to one side thereof, an outer diameter of the pore of the holder is equal to that of the hydraulic cylinder, the pore is used to receive the hydraulic cylinder so that the hydraulic cylinder is connected with the oil cup, the hydraulic piston includes the connecting post disposed on a rear end thereof, and the connecting post includes the first threads arranged thereon to screw the connecting post with the orifice of the positioning nut.

### BRIEF DESCRIPTION OF THE DRAWINGS

FIG. 1 is a cross sectional view showing the assembly of a conventional hydraulic brake;

FIG. 2 is a perspective view showing the exploded components of a hydraulic brake according to a preferred embodiment of the present invention;

FIG. 3 is a perspective view showing the assembly of the hydraulic brake according to the preferred embodiment of the present invention;

FIG. 4 is a plan view showing the assembly of the hydraulic brake according to the preferred embodiment of the present invention;

FIG. 5 is a cross sectional view showing the operation of hydraulic brake according to the preferred embodiment of the present invention;

FIG. 6 is another cross sectional view showing the operation of hydraulic brake according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

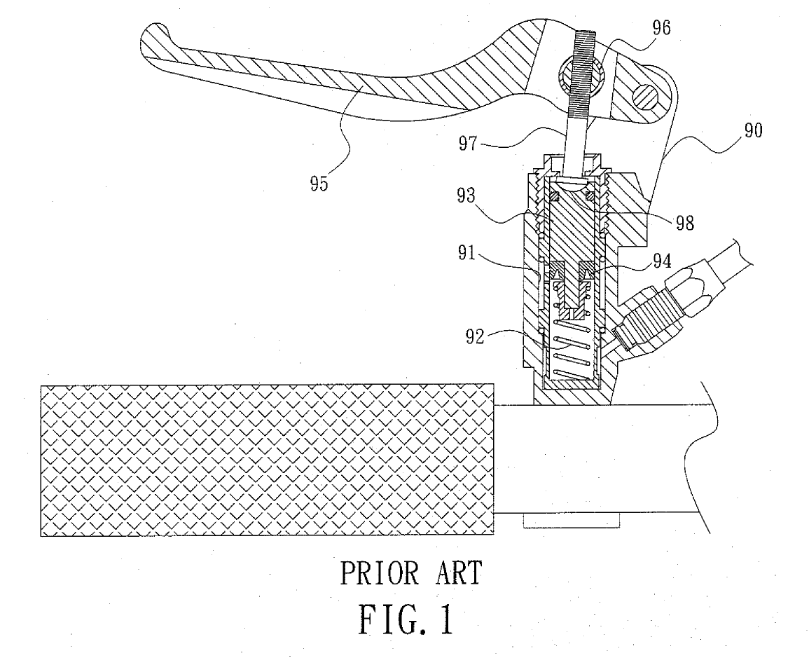

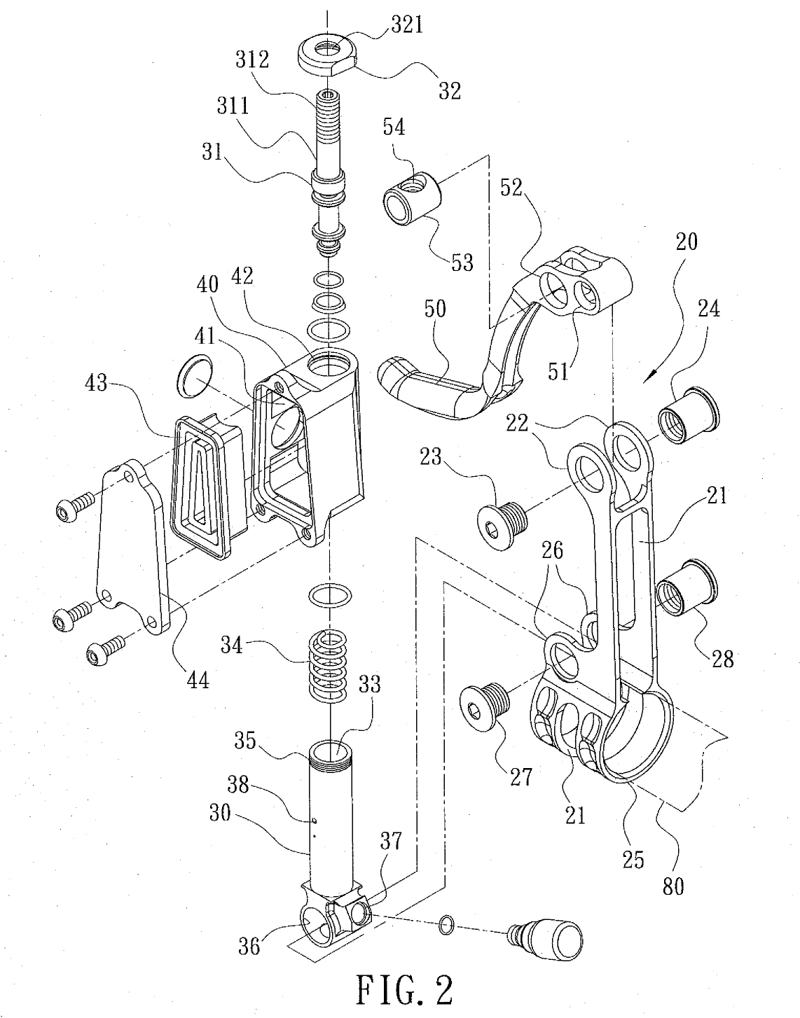

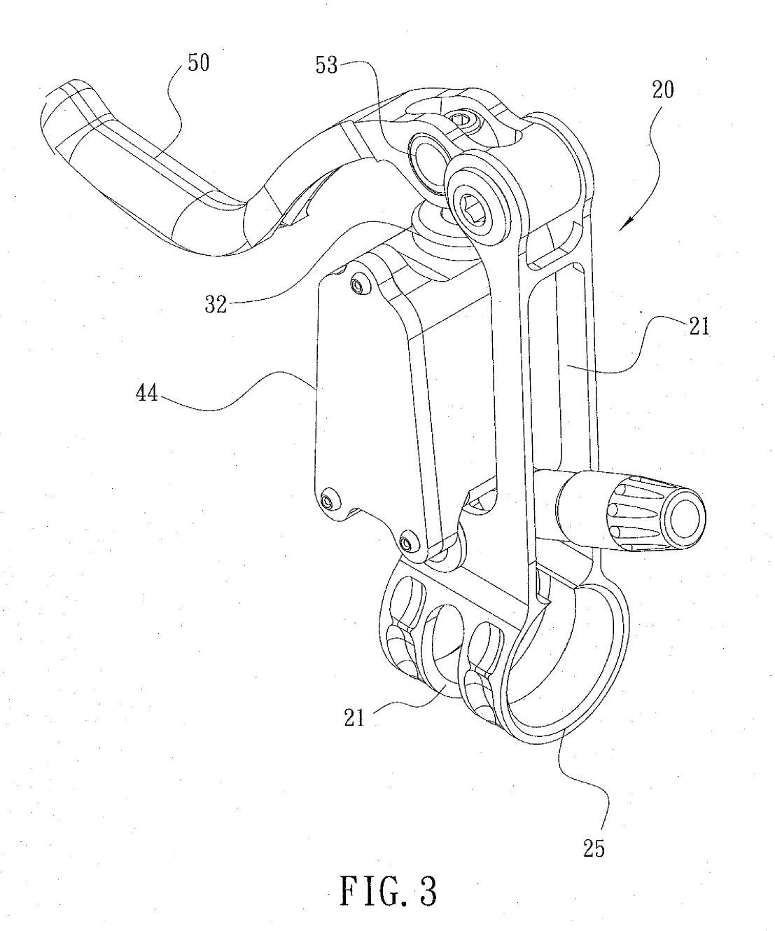

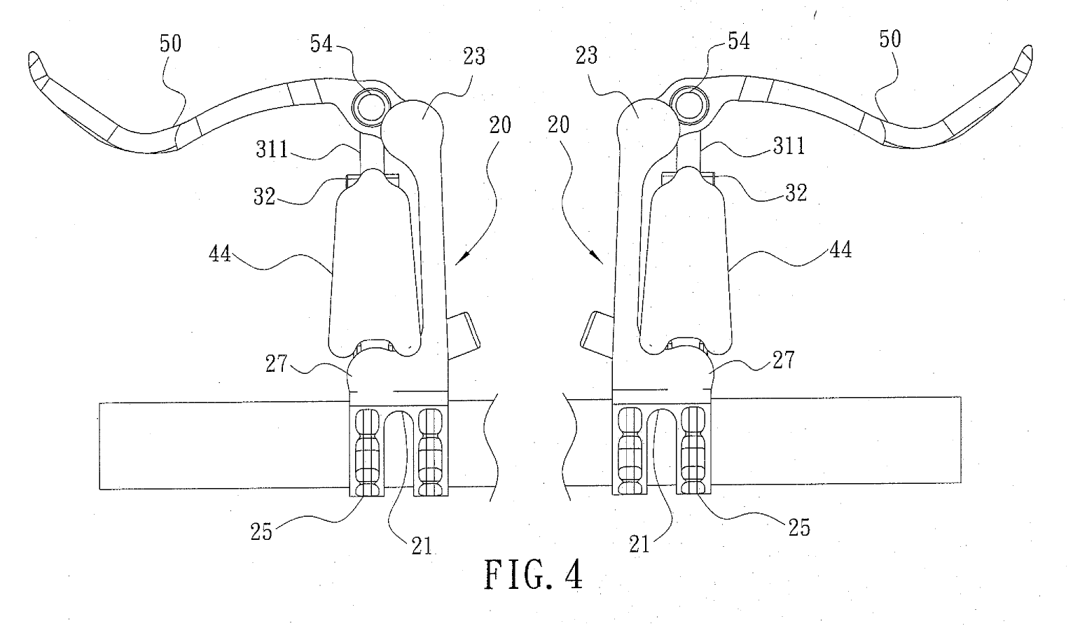

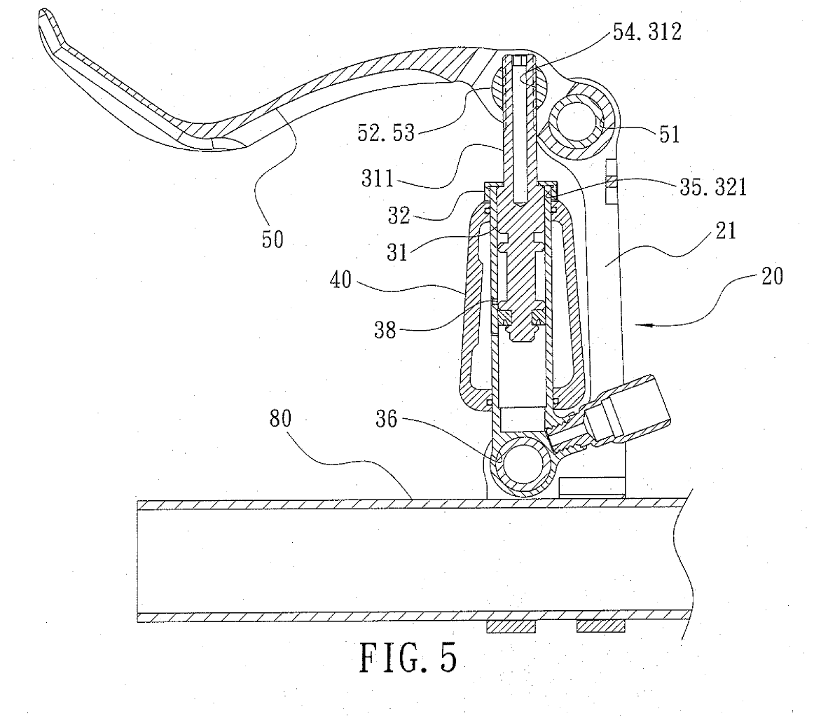

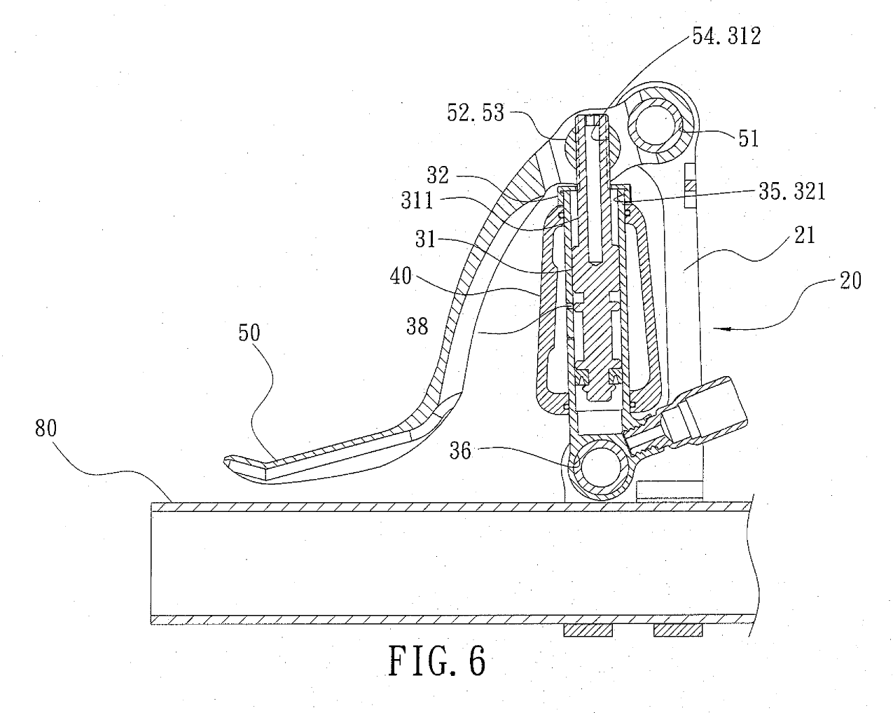

Referring to FIGS. 1-6, a hydraulic brake in accordance with a preferred embodiment of the present invention is used to a handle 50 of a two wheel vehicle, and an adjustable nut 53 of the handle 50 is screwed with a connecting post 311 of a hydraulic piston 31, the hydraulic piston 31 is used to push hydraulic oil in an oil chamber 33 when the handle 50 is pressed by a user, wherein when the hydraulic piston 31 operates in the oil chamber 33, a hydraulic cylinder 30 is micro-adjusted with a changing angle of the handle 50 so that the hydraulic piston 31 acts linearly, thus having a smooth brake and lowering weight of the hydraulic brake.

The hydraulic brake comprises a body 20, the hydraulic cylinder 30, the hydraulic piston 31, a holder 40, the adjustable nut 53, and the handle 50, wherein the body 20 is integrally formed, includes a plurality of hollow portions 21 to lower weight, includes two first tabs 22 disposed on an upper side thereof, and each first tab 22 is inserted and screwed by a first screw 23 and a first nut 24 to axially connect the handle 50 onto the body 20; the handle 50 includes an axial hole 51 and a through bore 52 to receive the adjustable nut 53 arranged on a front end thereof, the adjustable nut 53 includes a screw aperture 54 formed on a middle section thereof to be screwed with first threads 312 of the connecting post 311 of the hydraulic piston 31; the body 20 also includes a retaining sleeve 25 and two second tabs 26 to be inserted by a second screw 27 and a second nut 28 so that the hydraulic cylinder 30 is axially connected with the body 20 and the body 20 is retained onto a grip 80; the hydraulic cylinder 30 includes the oil chamber 33 fixed on a central portion thereof and is fitted to the holder 40, the oil chamber 33 includes a returning spring 34 and the hydraulic piston 31 installed therein, and a positioning nut 32 having an orifice 321 is screwed with second threads 35 on a top end of the hydraulic cylinder 30 so that the hydraulic piston 31 is limited in the oil chamber 33 to operate and the holder 40 is not disengaged, the hydraulic cylinder 30 also includes an opening 36 mounted on a bottom end thereof, and the opening 36 includes an outlet 37 fixed on one side thereof to be coupled with the second tabs 26 of the body 20, the hydraulic cylinder 30 includes a plurality of mouths 38 secured on a middle section thereof to communicate with an oil cup 43, and a hydraulic cylinder axis of the hydraulic cylinder 30 is parallel to a longitudinal clamp axis; the holder 40 includes a receiving room 41 to receive the oil cup 43 and a pore 42 arranged thereon, and includes a cover 44 disposed to one side thereof and screwed with the oil cup 43 by using a plurality of screw elements, an outer diameter of the pore 42 of the holder 40 is equal to that of the hydraulic cylinder 30, and the pore 42 is used to receive the hydraulic cylinder 30 so that the hydraulic cylinder 30 is connected with the holder 40, the hydraulic piston 31 includes the connecting post 311 disposed on a rear end thereof, and the connecting post 311 includes the first threads 312 arranged thereon to screw the connecting post 311 with the orifice 321 of the positioning nut 32, such that the hydraulic brake is assembled to be operated smoothly and obtain a light weight.

While we have shown and described various embodiments in accordance with the present invention, it is clear to those skilled in the art that further embodiments may be made without departing from the scope of the present invention.

What is claimed is:

1. A hydraulic brake being used to a handle of a two wheel vehicle and comprising:
a body, a hydraulic cylinder, a hydraulic piston, a holder, and an adjustable nut, and the handle; wherein
the body includes two first tabs disposed on an upper side thereof, the handle includes an axial hole and a through bore to receive the adjustable nut arranged on a front end thereof, the adjustable nut includes a screw aperture formed on a middle section thereof to be screwed with first threads of a connecting post of the hydraulic piston, the body includes a retaining sleeve and two second tabs disposed on a bottom side thereof, the hydraulic cylinder includes an oil chamber fixed on a central portion thereof and is fitted to the holder, a positioning nut having an orifice is screwed with second threads on a top end of the hydraulic cylinder so that the hydraulic piston is limited in the oil chamber to operate and the holder is not disengaged, the holder includes a receiving room to receive an oil cup and a pore arranged thereon, and includes a cover disposed to one side thereof, an outer diameter of the pore of the holder is equal to that of the hydraulic cylinder, the pore is used to receive the hydraulic cylinder so that the hydraulic cylinder is connected with the oil cup, the hydraulic piston includes the connecting post disposed on a rear end thereof, and the connecting post includes the first threads arranged thereon to screw the connecting post with the orifice of the positioning nut;
wherein a hydraulic cylinder axis is parallel to a longitudinal clamp axis;
wherein each first tab is inserted and screwed by a first screw and a first nut to axially connect the handle onto the body;
wherein the retaining sleeve and the second tabs of the body are inserted by a second screw and a second nut so that the hydraulic cylinder is axially connected with the body and the body is retained onto a grip;
wherein the oil chamber includes a returning spring and the hydraulic piston installed therein;
wherein the hydraulic cylinder includes an opening mounted on a bottom end thereof, and the opening includes an outlet fixed on one side thereof to be coupled with the second tabs of the body;
wherein the hydraulic cylinder includes a plurality of mouths secured on a middle section thereof to communicate with the oil cup;
wherein the cover is disposed to one side of the holder and screwed with the oil cup by using a plurality of screw elements.

2. The hydraulic brake as claimed in claim 1, wherein the hydraulic piston is used to push hydraulic oil in an oil chamber when the handle is pressed by a user.

3. The hydraulic brake as claimed in claim 1, wherein when the hydraulic piston operates in the oil chamber, the hydraulic cylinder is micro-adjusted with a changing angle of the handle so that the hydraulic piston acts linearly.

4. The hydraulic brake as claimed in claim 1, wherein the body is integrally formed, includes a plurality of hollow portions to lower weight.
